(19) United States
(12) Patent Application Publication
(10) Pub. No.: US 2023/0407895 A1
(43) Pub. Date: Dec. 21, 2023

(54) ADJUSTMENT ELEMENT AND AN INSTALLATION METHOD FOR AN ADD-ON PART WITH THE HELP OF THE ADJUSTMENT ELEMENT

(71) Applicant: BÖLLHOFF VERBINDUNGSTECHNIK GmbH, Bielefeld (DE)

(72) Inventors: Michaela Mücke, Detmold (DE); Michael Kahre, Herford (DE); Christian Kolbeck, Lohne (DE)

(21) Appl. No.: 18/205,430

(22) Filed: Jun. 2, 2023

(30) Foreign Application Priority Data
Jun. 15, 2022 (DE) DE102022115126.3

(51) Int. Cl. F16B 5/02; B29C 45/14

(52) U.S. Cl. CPC F16B 5/0233; B29C 45/14467; B29C 2045/14524; B29L 2001/007

(57) ABSTRACT

An adjustment element with which a component is fastenable and positionable in the space and including a sleeve-like hollow screw with a first and a second axial end and an outer thread to which a component can be retained and can be positioned in axial direction of the hollow screw, adjacent to the first axial end, the hollow screw has a fastening collar which is configured integrally and projects radially to the inside and which encompasses a tubular fastening opening of the hollow screw, and an axial support sleeve arranged within the tubular fastening opening so that the hollow screw is rotatably fastenable with a fastening means to a component in a rotatable manner, which passes through the axial support sleeve.

### CROSS REFERENCE TO RELATED APPLICATIONS

This application claims the priority to German Patent Application No. DE102022115126.3 filed on Jun. 15, 2022, and the content of this priority application is incorporated herein by reference in its entirety.

### TECHNICAL FIELD

The present disclosure is related to an adjustment element with which a component is fastenable and positionable in the space. Furthermore, the present disclosure relates to an installation method with which an add-on part is fastenable to a structural component with the help of the adjustment element. At the same time, beside the fastening, the adjustment element allows a positioning of the add-on part with respect to the structural component. Furthermore, the disclosure comprises a manufacturing method for the adjustment element.

### BACKGROUND

DE 10 2007 002 699 A1 describes a fastening device for a motor vehicle. This fastening device consists of a hollow screw with an outer thread that is fixed in a fastening opening of a structural component with the help of a thread bolt. As the inner diameter of the hollow screw is larger than an outer diameter of the fastening screw, this combination of fastening screw and hollow screw provides a lateral tolerance compensation. An adjustment part with inner thread is arranged on the outer thread of the hollow screw. By rotating the adjustment part, the axial position of the adjustment part on the hollow screw is changeable. On the other hand, an add-on part is connected with the adjustment part so that a rotation of the adjustment part is possible, though a relative displacement between the add-on part and the adjustment part is not. Beside the plurality of the components of the fastening element, the combination of adjustment part, hollow screw and fastening screw claims a lot of space which is available to a limited extent only in the motor vehicle.

DE 10 2016 207 868 A1 describes an assembly module for a vehicle light. This assembly module is also comprised of a hollow screw with an outer thread. While the hollow screw is fastened to a structural component, a light is screwed on its outer thread. Depending on the screw-in depth of the hollow screw into the housing of the light, the axial position of the light with respect to the hollow screw is settable. A fastening sleeve is arranged within the hollow screw by means of an axially fixed rotation connection. This fastening sleeve provides a fastening opening or fastening channel, respectively, which is passed through by the shaft of a thread bolt. The thread bolt in turn serves for the fastening of the hollow screw to a structural component with the help of the fastening sleeve. While the fastening sleeve is firmly screwed to the structural component, the axial, firm rotation connection between fastening sleeve and hollow screw guarantees a rotating of the hollow screw despite fastening the fastening sleeve to the structural component. This axial, firm rotation connection between fastening sleeve and hollow screw is relatively laborious as despite the movability of the hollow screw to be provided, it must provide a sufficient mechanical stability for fastening the vehicle light during the lifetime of the vehicle. Via the axially firm rotation connection, the distance between hollow screw and structural component must furthermore be adjusted so that the hollow screw is rotatably arranged without any further ado. This necessary preciseness demands high standards to the production of the assembly module compared with similar constructions of the state of the art.

WO 2019/110366 describes a vehicle light fastening module similar to the previously discussed DE 10 2016 207 868 A1. Here, the light is also fastened by means of an outer thread of the hollow screw. The hollow screw in turn is fixed to a fastening opening of a structural component. For this purpose, the hollow screw comprises a perforated disc on its axial end which faces the structural component. This perforated disc has a central opening which may be passed through by a thread bolt. Furthermore, inside the hollow screw, the perforated disc is retained in a circumferential groove at an axially firm position. The combination of groove and perforated disc allows a lateral displacement in order to compensate possible tolerances between the hollow screw and the fastening opening in the structural component. For attaching the thread bolt which passes through the perforated disc, a blind rivet nut is provided in a fastening opening of the structural component. The thread bolt is screwed into this blind rived nut. The connection of perforated disc and hollow screw provides an axially firm positioning of the hollow screw while being rotatable at the same time about its longitudinal axis. It is therefore possible to rotate the hollow screw in order to change an axial positioning of the light on the outer thread of the hollow screw.

Another adjustment element is disclosed by DE 20 2007 016 945 U1. This adjustment element fastens an add-on part in the space and at the same time, it provides a tolerance compensation in the three spatial directions x, y, z. For this purpose, the adjustment element has a hollow screw with an inner and an outer thread. A thread sleeve is screwed into the hollow screw which can be screwed together firmly with a structural component with the help of a thread bolt. As the inner diameter of the thread sleeve is larger than the outer diameter of the fastening thread bolt, the thread sleeve in combination with the outer hollow screw guarantees a lateral tolerance compensation. In addition to that, the hollow screw that is arranged on the thread sleeve is axially displaceable by rotation so as to change an axial position of a fastening add-on part. Although this adjustment element provides a big variability in terms of the displacement possibilities into all three spatial direction, it is, at the same time, laborious in terms of production due to the number of individual parts.

It is therefore an object of at least some implementations of the present disclosure to provide a structurally simple adjustment element which guarantees a reliable installation of an add-on part to a structural component.

### SUMMARY

The above object is solved by an adjustment element, by a structural component with a fastening opening, to which the adjustment element is fastened with a thread bolt, as well as by an installation method with which an add-on part, which may be a light, is fastenable and positionable to a structural component, which may be a vehicle body. Furthermore, the above object is solved by a production method of the adjustment element. Advantageous embodiments and further developments of the present disclosure result from the following description, the accompanying drawings as well as the appending claims.

With the adjustment element, a component is fastenable and positionable in the space. Positionable means that in the fastened state of the adjustment element, the component is displaceable on a hollow screw in axial direction of the adjustment element by rotation of the hollow screw. By that, a distance between component and structural component is changed. The adjustment element includes the following features: a sleeve-like hollow screw with a first and a second axial end, a drive feature and an outer thread to which a component can be retained and can be positioned in axial direction of the hollow screw, adjacent to the first axial end, the hollow screw comprises a fastening collar which is configured integrally and projects radially to the inside and which encompasses a tubular fastening opening of the hollow screw, and an axial support sleeve is arranged within the tubular fastening opening so that the hollow screw is rotatably fastenable with a fastening means to a component in a rotatable manner, which passes through the axial support sleeve.

The adjustment element consists of the sleeve like hollow screw. It comprises an outer thread at its outside which is fastenable in a component, e.g. an add-on part such as a vehicle light, by being screwed into a corresponding opening. For this purpose, a self-grooving or self-locking thread is for example suitable as outer thread. Other forms of threads may be used which guarantee a reliable retention between the hollow screw and the add-on part.

The outer thread on the outer side which extends along the longitudinal axis of the hollow screw guarantees the possibility of positioning the add-on part in axial direction of the hollow screw or the adjustment element, respectively, with the help of rotating the hollow screw. Even after the installation or fastening of the adjustment element to a structural component, e.g. a vehicle body, the kind of fastening the hollow screw which may allow a rotating of the hollow screw about its longitudinal axis. At the same time, the position of the hollow screw is determined so that there is only one degree of freedom for the rotation of the hollow screw. This function of the adjustment element may be guaranteed by means of a fastening collar projecting radially to the inside within the sleeve like hollow screw. This fastening collar may provide a tubular fastening opening of the hollow screw due to its axial extension. This tubular fastening opening extends through the fastening means, which may be a thread bolt, in order to screw same into a thread opening of a structural component, here, which may be the vehicle body. A blind rivet, a latching bolt or the like may be used as the fastening means, which are held in a fastening opening of the structural component.

In order to provide a rotation of the hollow screw even after fastening the hollow screw to the structural component with the help of the thread bolt, an axial support sleeve is arranged within the tubular fastening opening of the hollow screw. This support sleeve may provide for a block screw connection or block fastening connection between the fastening means and the structural component, wherein at the same time, a sufficient rotating movability of the hollow screw about the support sleeve is maintained. Thus, the adjustment element provides a relatively simple construction despite its functional complexity. In this way, the installation effort is reduced in the same way as the production effort of the adjustment element.

According to a further embodiment of the adjustment element, the axial support sleeve may be flush with the hollow screw at the first axial end and at the same time, it projects beyond an end, which is inside the hollow screw, of the tubular fastening opening so that the hollow screw is rotatably fastenable with the fastening means.

The axial support sleeve is configured longer than a longitudinal extension of the tubular fastening opening. This provides the possibility that the support sleeve is fastened at a position of a fastening opening in the structural component with the help of the fastening means, which may be a thread bolt, wherein furthermore, a rotating of the hollow screw about the support sleeve is guaranteed. By doing so, the hollow screw is firmly positioned in the space while a rotating of the hollow screw allows an axial displacement of an add-on part that is fastened on the outer thread of the hollow screw.

In order to fasten the support sleeve which may be in a block screw connection or generally in a block fastening connection at the structural component, the fastening means which passes through the support sleeve, which may be the thread bolt, rests against the inner axial end of the support sleeve, with regard to the hollow screw, with the underside of its head. According to different embodiments, this support may be realized by means of a head of the thread bolt that is sufficiently big in radial direction or by means of a corresponding support disc between the underside of the head of the thread bolt or generally the fastening means and the neighboring axial end of the support sleeve.

According to a further embodiment, the support disc with central opening which has already been referred to above is arranged to the end of the support sleeve which lies within the hollow screw, wherein the support disc has an outer diameter exceeding that of the axial support sleeve and the opening diameter of which is smaller than an inner diameter of the axial support sleeve so that a lateral tolerance compensation can be provided by means of a combination of the axial support sleeve, the support disc and the fastening means, which may be the thread bolt.

The support disc with the central opening may provide the friction fit connection between the fastening means of the support sleeve and the structural component. Additionally, the support disc may guarantee that a thread bolt may also be used, the head diameter of which is less than an inner diameter of the support sleeve. Furthermore, the support disc supports a radial displacement of a shaft of the fastening means or the thread bolt within the support sleeve so as to be able to compensate possible tolerances. In this way, it is possible that the fastening thread bolt passes through same eccentrically, too, i.e. parallel but not coaxial with respect to the longitudinal axis of the support sleeve, and fastens the hollow screw to the structural component. Furthermore, the support disc may guarantee that the mechanical retention forces are transmitted from the underside of the head of the fastening means or the thread bolt via the support disc to the entire adjacent rim of the support sleeve. In this way, the mechanical retention tension which is built up by the thread bolt is evenly transmitted to the structural component.

According to a further embodiment of the adjustment element, the hollow screw comprises the drive feature on an inside and/or an outside and no inner thread on the inside.

To be able to guarantee the functionality of the hollow screw for an axial positioning of the add-on part on the outer thread side of the hollow screw, at least one drive feature may be provided. According to a first embodiment, this drive feature may be arranged inside, i.e. which may be on the inside of the hollow cylindrical hollow screw. This drive feature forms the basis for the engagement of a tool so that a form fit connection between the inside of the hollow screw and the tool is established. This form fit connection enables a rotating of the hollow screw, however, and may do so without stressing or displacing the hollow screw in axial direction.

According to a further configuration, a drive feature may be provided on the outside of the hollow screw. This drive feature on the outside is for example a polygon in order to rotate the hollow screw with a correspondingly form fit acting tool by means of an engagement from the outside.

According to a further configuration, both an inner as well as an outer drive feature may be provided at the hollow screw of the adjustment element in order to be able to provide the highest possible flexibility for the axial positioning of an add-on part on the outer thread of the hollow screw of the adjustment element.

According to a further configuration of the adjustment element, no thread may be provided at the inside of the hollow cylindrical hollow screw. In this manner, an additional production effort is avoided as only the fastening element or the thread bolt must engage the tubular fastening opening. This does, however, not require the need of an inner thread as no screw connection between the thread bolt or another sleeve or component arranged inside the hollow screw is provided.

Following the above description, the hollow screw includes an outer polygon as drive element at the first axial end according to a further embodiment, the polygon at least partially encompassing the tubular fastening opening.

According to a further configuration of the adjustment element, the hollow screw may include a form fit inner drive feature, which may be an inner polygon, adjacent to the second axial end.

In addition, the above-mentioned drive features may be combined with each other in the hollow screw.

According to a further embodiment, the hollow screw and/or the support sleeve may comprise a remainder of a released and previously connecting predetermined breaking point between the support sleeve and the hollow screw.

According to a production route of the adjustment element, the hollow screw and the support sleeve may be jointly produced in an injection molding tool or an injection mold. During the injection molding, the hollow screw and the support sleeve are generated as an interconnected part being connected with each other by means of a predetermined breaking point. During demolding the hollow screw and support sleeve at the injection molding tool, the predetermined breaking point is released and the support sleeve is inserted into the hollow screw.

According to a further embodiment of the adjustment element, the hollow screw and the support sleeve may be made of the same plastic material or of different plastic materials.

The above-described injection molding method is implemented depending on the requirements to the adjustment element as a 1K injection molding method or as a 2K injection molding method. Consequently, the hollow screw and the support sleeve are made of the same plastic material when a 1K injection molding method is used, or the hollow screw and the support sleeve are made of different plastic materials when a 2K injection molding method is used.

Furthermore, the present disclosure includes a structural component with a fastening opening to which the adjustment element according to one of the above-described configurations is fastened with a fastening means, which may be a thread bolt, a blind rivet or the like. According to a further embodiment, the structural component may be made by a vehicle body. The fastening opening may include a thread which is provided in the opening directly, which is provided by the blind rivet nut or which is provided by a welding nut.

According to a further configuration of the structural component, a component, which may be a vehicle light, is fastened on the outer thread of the hollow screw of the adjustment element so that tolerances between the structural component and the component are settable.

Due to its construction and fastening, the hollow screw may be arranged rotatably within the adjustment element even when in the fixed state. Thus, firstly, a position of the component with regard to the structural component is fixed by the thread connection between the component and the hollow screw. The available rotation of the adjustment element with the help of the hollow screw guarantees a change of the relative distance between the component and the structural component, apart from the positioning of the component relative to the structural component. The reason is that with rotation of the hollow screw, the component on the outer thread of the hollow screw is displaced in axial direction which in turn changes the distance between the structural component and the component on the hollow screw.

For this purpose, the outer thread of the hollow screw may be designed as a self-inhibiting thread. Therefore, a reliable retention of the component on the outer thread of the hollow screw is guaranteed despite the axial displacement of the component with respect to the structural component based on the rotation of the hollow screw.

Furthermore, the present disclosure includes an installation method with which another part, which may be a light, is fastenable and positionable to a structural component, which may be a vehicle body. The installation method includes the following steps: screwing-in a hollow screw of the above-described adjustment element according to the different construction alternatives in a retention opening of the add-on part, fastening the hollow screw with add-on part to a fastening opening of the structural component with a fastening means that is arranged within the tubular fastening opening of the fastening collar, and rotating the hollow screw that is fastened to the structural component so that the add-on part is displaced along a longitudinal axis of the hollow screw.

The installation method is based on the space-saving and economic construction of the above-described adjustment element. Accordingly, it is produced with low effort and subsequently also installed. In a first step, the hollow screw of the adjustment element may be screwed into a retention opening of the add-on part, which may be a vehicle light. After that, the hollow screw is fastened in a thread opening of the structural component, which may be the vehicle body, with the help of a thread bolt. According to different embodiments, the thread opening may consist of a bore hole with inner thread, of a blind rivet nut fastened in a bore hole or of a welding nut that is arranged adjacent to an opening. The positioning of the add-on part with respect to the structural component is determined by the thread connection of the hollow screw with the structural component with the help of the thread bolt. In this fastening between add-on part and structural component, it is only the hollow screw which has the degree of freedom to rotate itself. This degree of freedom may be used with the help of a tool in order to set a distance between the structural component and the add-on part. Accordingly, a tool engages the hollow screw or attaches to the hollow screw and rotates it about its longitudinal axis. In this way, the add-on part that is fastened on the outer thread of the hollow screw is displaced along the longitudinal axis of the hollow screw until the suitable distance between structural component and add-on part has been reached.

According to a further configuration of the installation method, the same includes the following further step: providing the fastening opening of the structural component with a thread, which may be by means of a welding nut or a blind rivet nut which is suitably configured as a fastening means with respect to a thread bolt.

According to a further configuration, the installation method includes the further step: arranging the thread bolt in combination with a washer within the axial support sleeve so that the hollow screw is rotatably fastened to the structural component.

According to a constructive configuration of the support sleeve within the adjustment element, the axially interior end of the support sleeve may reach over the fastening collar which may project radially to the inside. When the adjustment element is fastened with the help of a thread bolt and a washer, the washer rests upon the inner axial end of the support sleeve while the thread bolt establishes a friction fit connection to the thread opening in the structural component. The circumferential support of the washer on the free axial end of the support sleeve may allow a radial displacement of the thread bolt in the inner free space of the support sleeve. In this way, tolerances between the fastening opening in the structural component and the arrangement of the adjustment element and thus of the add-on part arranged at the adjustment element are realizable in lateral direction. That means that overall, the adjustment element may not only allow a tolerance compensation in axial direction, i.e. in longitudinal direction of the hollow screw but also a tolerance compensation perpendicular to the longitudinal axis of the hollow screw due to the combination of support sleeve and thread bolt.

Furthermore, the attachment of the washer or of the head of the thread bolt to the free inner axial end of the support sleeve may guarantee that the hollow screw can freely rotate around the support sleeve despite being fastened by the thread bolt, as the screw connection between the thread bolt and the structural component does not generate any immovable friction fit between the hollow screw and the structural component. Rather, the axial projection of the inner end of the support sleeve guarantees a free space between the washer or the underside of the head of the thread bolt and the structural component. It is therefore possible that the adjustment element, which may be the hollow sleeve, is rotatable also when in the state of being fastened to the structural component by means of a corresponding tool.

According to a further embodiment, the installation method includes the further step: rotating the fastened hollow screw by means of an outer or an inner drive feature in order to change the axial position of the add-on part on the hollow screw.

Furthermore, the present disclosure also includes an injection molding method with which an adjustment element according to one of the above-described configurations can be produced and which includes the following steps: providing an injection mold having the complementary mold features with respect to the adjustment element, injection molding the adjustment element with a first plastic material.

An injection molding of the support sleeve may take place in the injection mold so that the hollow screw and the support sleeve are available being made of the same plastic material and connected by means of a predetermined breaking point.

According to a further configuration of the injection molding method, a demolding of the hollow screw with the support sleeve may take place, wherein the hollow screw and the support sleeve are separated from each other at the predetermined breaking point and the support sleeve is arranged in the tubular fastening opening.

As the hollow screw and the support sleeve are not post-processed after the separating during the demolding, the hollow screw and/or the support sleeve comprise a remainder of the separated predetermined breaking point.

According to a further configuration, the injection molding method may be a 1K injection molding method and the hollow screw and the support sleeve are made of the same plastic material or the injection molding method is a 2K injection molding method and the hollow screw and the support sleeve are made of different plastic materials.

### BRIEF DESCRIPTION OF THE DRAWINGS

In the following, the present disclosure will be described in detail based on the drawings. In the drawings, the same reference signs denote the same components, features and/or elements. They show:

FIG. 1 an embodiment of a connection between a structural component and an add-on part with the help of an adjustment element in a lateral sectional view,

FIG. 2 an embodiment of a hollow screw as a part of the adjustment element,

FIG. 3 an embodiment of the adjustment element in an axial top view from the side, facing away from the fastening collar,

FIG. 4 a perspective lateral view of an embodiment of the hollow screw, with the support sleeve that has not yet been arranged in the tubular fastening opening,

FIG. 5 a perspective lateral view of an embodiment of the hollow screw with the support sleeve arranged in the tubular fastening opening,

FIG. 6 different embodiments of the support sleeve,

FIG. 7 an embodiment of the support sleeve with outer ribbing,

FIG. 8 a perspective top view on the side of the hollow screw facing away from the fastening collar,

FIG. 9 a lateral sectional view of the hollow screw with an inner form fit drive feature,

FIG. 10 a perspective top view on the side of the hollow screw facing away from the fastening collar with another inner form fit drive feature,

FIG. 11 a perspective lateral view of a component connected with a structural component with the help of the adjustment element,

FIG. 12 a lateral sectional view of a component connected with the adjustment element in an unfastened arrangement of the adjustment element in a fastening opening of the structural component,

FIG. 13 a lateral sectional view of a component connected with the adjustment element in a fastened arrangement of the adjustment element in a fastening opening of the structural component,

FIG. 14 a perspective view of a connection of structural component and component with a tool for adjusting the adjustment element,

FIG. 15 a further perspective view of a connection of structural component and component with a tool for adjusting the adjustment element,

FIGS. 16, 17 and 18 individual sequences of the installation method of the adjustment element during connecting structural component and add-on part,

FIGS. 19 and 20 individual sequences of the setting method of the adjustment element for setting an axial distance between the structural component and the add-on part during connecting structural component and add-on part,

FIG. 21 a lateral sectional view of a connection of structural component and add-on part via the adjustment element in combination with a tool acting in a form fit manner for rotating the hollow screw,

FIG. 22 a radial sectional view of the adjustment element from the side facing away from the fastening collar with a tool engaging in a form fit manner for rotating the hollow screw,

FIG. 23 a lateral sectional view of the component connected with the adjustment element by means of an alternative fastening means in a fastened arrangement of the adjustment element in a fastening opening of the structural component,

FIG. 24 a top view on the structural component according to FIG. 23,

FIG. 25 a lateral sectional view of a component connected with the adjustment element by means of a further alternative fastening means in an unfastened arrangement of the adjustment element in a fastening opening of the structural component,

FIG. 26 a lateral sectional view of a component connected with the adjustment element by means of the further alternative fastening means in a fastened arrangement of the adjustment element in a fastening opening of the structural component, and

FIG. 27 a flow chart of an embodiment of an installation method of the adjustment element.

### DETAILED DESCRIPTION

FIG. 1 shows an embodiment of a connection of a structural component S, which may be a vehicle body, with a component or add-on part A, which may be a vehicle light. The structural component S and the add-on part A are connected with each other by means of an adjustment element 1, an embodiment of which can be seen in a sectional view in FIG. 1.

The structural component S comprises a fastening opening B with an inner thread. According to a further embodiment, the fastening opening B may be provided by means of a blind rivet nut C with inner thread or by means of a welding nut (not shown) or by means of a thread opening directly in the structural component S.

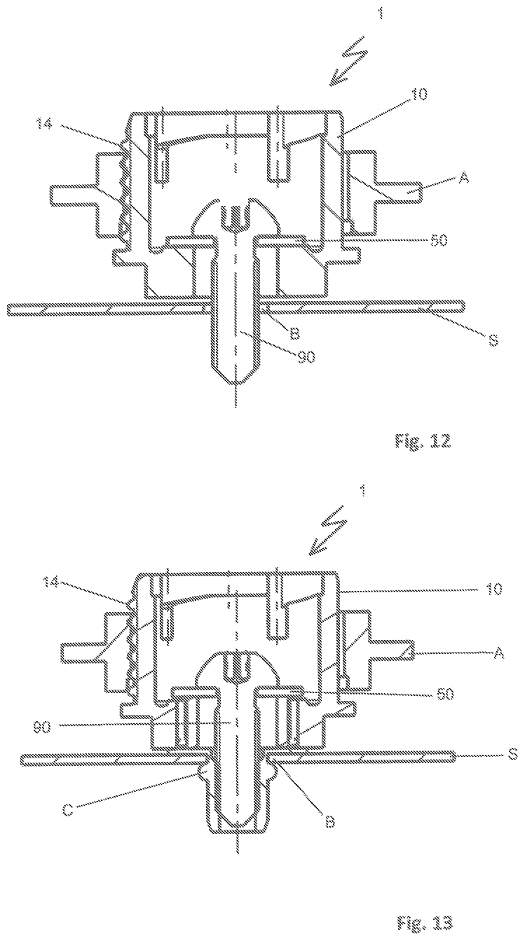

FIG. 1 shows the blind rivet nut C in a not yet crimped state in the fastening opening B. FIG. 13 shows an embodiment in which the blind rivet nut C may have already been fastened in the fastening opening B of the structural component S.

The structural component may be provided with a threadless opening. The adjustment element 1 can be fastened to this opening with a blind rivet, a plug connection, a bayonet connection, a locking pin or the like.

In the following, a thread bolt 90 as an exemplary fastening means is described.

The adjustment element 1 according to FIG. 1 may consist of a sleeve like hollow screw 10. The sleeve like hollow screw 10 is formed similar to a hollow cylinder with a circumferential wall 12. The circumferential wall 12 comprises an outer thread 14 on its radial outside. The hollow screw 10 and thus the adjustment element 1 may be screwed together with the add-on part A via the outer thread 14.

The outer thread 14 may have a self-inhibiting configuration. The hollow screw 10 can thus be rotated in an opening of the add-on part A without the thread connection between the hollow screw 10 and the add-on part A releasing.

The thread connection between the hollow screw 10 and the add-on part A has the advantage that a rotating of the hollow screw 10 about its longitudinal axis L displaces the add-on part A relative with respect to the hollow screw 10 in the direction of the longitudinal axis L of the hollow screw 10. In this way, a distance Z between the add-on part A and the structural component S may be changeable and settable, as is shown in FIG. 1.

For this purpose, the hollow screw 10 is fastened to the structural component S, may be rotatable around its longitudinal axis L. The fastening is explained in more detail further below.

The bolt 90 may be rotatably screwed together with the structural component S by means of a central thread bolt 90. The thread bolt 90 is arranged in a tubular fastening opening 16 of the hollow screw 10. An inner diameter of the fastening opening 16 is larger than an outer diameter of the shaft 92 of the thread bolt 90. Based on this geometric configuration, the hollow screw 10 may be displaceable radially relative to the shaft 92 of the thread bolt 90, before the thread bolt 90 is firmly screwed together with the structural component S (see below). If the structural part S, to which the hollow screw 10 is fastened, is considered as an x-y-fastening plane with the fastening opening B arranged in there, the hollow screw 10 is displaceable in x-y-direction on the plane of the structural component S for the purpose of tolerance compensation before the thread bolt 90 is tightened (see FIG. 1).

Thus, beside the connecting of the add-on part A with the structural component S, the adjustment element 1 realizes a tolerance compensation in all three spatial directions x, y, z between the structural component S and the add-on part A. The adjustment possibility may guarantee in, for example, the vehicle construction the setting of desired gap sizes between a vehicle body and a vehicle lamp.

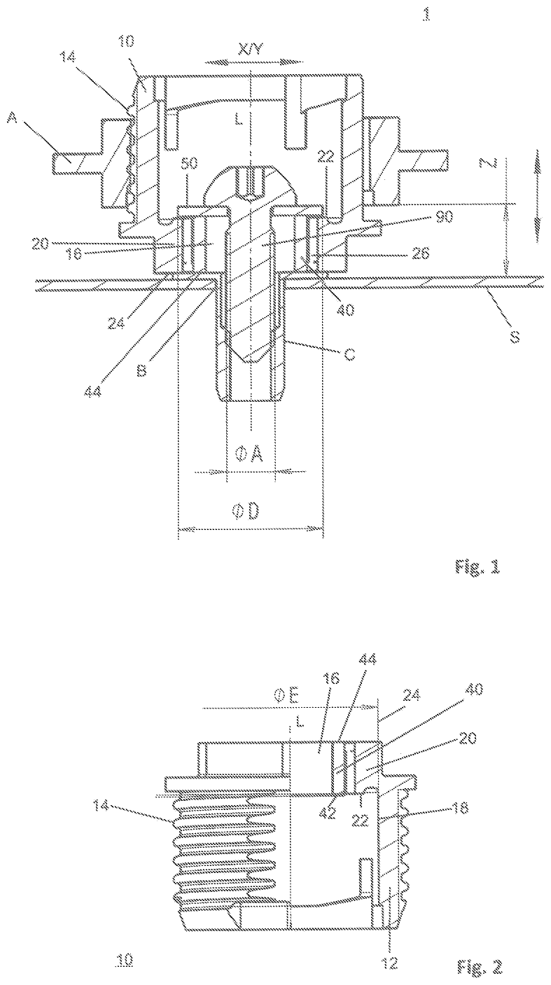

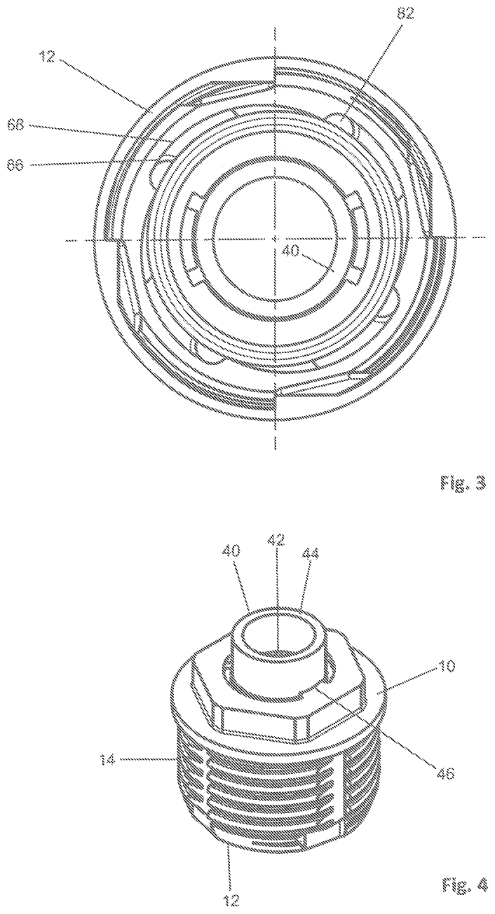

A similar embodiment of the hollow screw 10 is shown in FIG. 2. The hollow screw 10 extends along the longitudinal axis L with the thread 14 on the radial outer wall. The circumferential wall 12 may not comprise any thread on a radial inside 18.

Furthermore, the hollow screw comprises a fastening collar 20 projecting radially to the inside at a first axial end. The fastening collar 20 may extend inside of the hollow screw 10 in an enclosed manner, thus defining a tubular fastening opening 16.

The fastening collar 20 may have an inner radially extending rim 22 and an outer radially extending rim 24.

In the installed state of the adjustment element 1, the outer rim 24 rests against the structural component S directly or adjacent to it, which may be on the retention collar of a blind rivet nut C. An axial support sleeve 40 is arranged within the tubular fastening opening 16.

The support sleeve 40 may be configured longer than an axial distance between the inner rim 22 and the outer rim 24 of the fastening collar 20. If the hollow screw 10 is fastened to the structural component S, the outer rim 24 and the adjacent axial end 44, i.e. the end 44 of the support sleeve 40 which axially faces to the outside, rest against the structural component S. Accordingly, the outer rim 24 and the end 44 are aligned in a flush manner to one another. Due to the axial length of the support sleeve 40 in comparison with a length of the tubular fastening opening 16, expressed by the axial distance of the rims 22, 24, the end 42 of the support sleeve 40 which faces to the inside projects beyond the inner rim 22.

The axially inner end 42 of the support sleeve 40 may form a ring like abutment for a support disc 50. The support disc 50 is supported on the axially inner end 42 of the support sleeve 40. For this purpose, an outer diameter of the support disc 50 may be larger than an outer diameter of the support sleeve 40, thus guaranteeing that the support disc 50 is completely supported on the support sleeve 40 so as to transfer the mechanical fastening tensions from the underside of the head of the thread bolt 90 via the support sleeve 40 into the structural component S.

The support sleeve 40 may comprise a central opening 52. The shaft 92 of the thread bolt 90 passes through the central opening 52 in order to fasten the hollow screw 10 in the fastening opening B of the structural component S.

The difference in length between the tubular fastening opening 16 and the support sleeve 40 may guarantee a distance between the inner rim 22 of the fastening collar 20 and a side of the support disc 50 which faces the inner rim 22 in the fastened state of the hollow screw 10. This distance guarantees that even when in the fastened state, i.e. when screwed together with the structural component S, the hollow screw 10 is rotatable around its longitudinal axis L.

By that, which may be in the fastened state of the hollow screw 10, the distance Z between the add-on part A and the structural component S can be changed by rotating the hollow screw 10.

FIG. 4 shows the hollow screw 10 in combination with the support sleeve 40 after the production, which may be with a 2K injection molding method. Thus, the hollow screw 10 and the support sleeve 40 may consist of different plastic materials, which may be processed in the same manufacturing method. As a result, the hollow screw 10 and the support sleeve 40 shown here are available being connected by means of a predetermined breaking point 46 after the production method within the injection mold.

A 1K injection molding method may be used for the production of the hollow screw 10 and the support sleeve 40. The production routes which are described in the following may be applicable for both a 1K injection molding method as well as a 2K injection molding method.

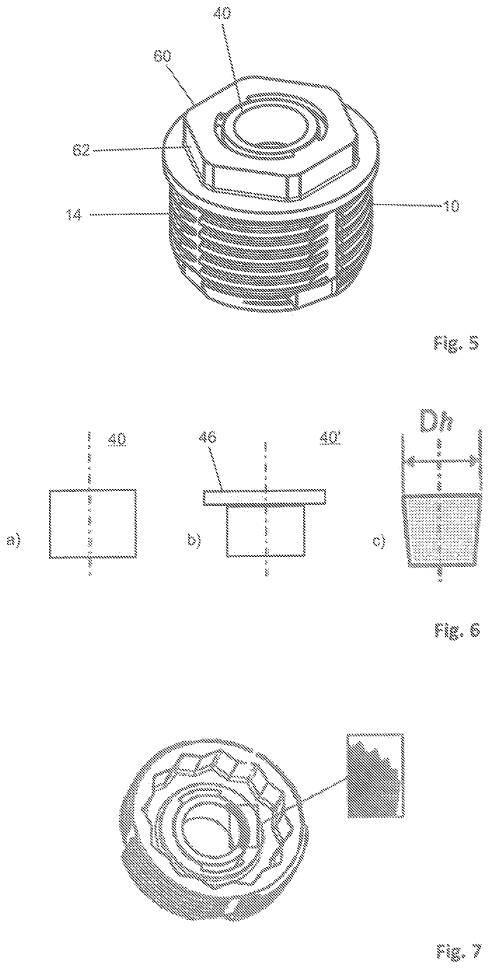

According to a first manufacturing alternative, the hollow screw 10 and the support sleeve 40 according to FIG. 4 may be present after concluding the 2K injection molding method. After demolding, the two parts are separated and the support sleeve 40 is inserted into the tubular fastening opening 16 of the hollow screw 10 so as to achieve the arrangement according to FIG. 5.

According to a further manufacturing alternative, the predetermined breaking point 46 may be automatically separated during demolding the arrangement according to FIG. 4 and the support sleeve 40 is pressed into the fastening opening 16. For this purpose, the injection molding tool is adapted in order to release the predetermined breaking point 46 and to connect the hollow screw 10 and the support sleeve 40 with one another. Again, the result may be the arrangement according to FIG. 5 with the advantage that after the demolding, no further work step is necessary. Rather, the combination of hollow screw 10 and support sleeve falls out of the injection molding tool and is processible.

The support sleeve 40 within the tubular fastening opening 16 realizes a play between the support sleeve 50 and the fastening collar 20 via its length. A clamping of the hollow screw 10 due to the connection between the thread bolt 90 and the structural component S is thereby avoided.

The support sleeve 40 is retained in the fastening opening 16 which may be in a friction fit manner. Therefore, a friction between the support sleeve 40 and an inner wall of the fastening opening 16 determines a rotation resistance of the hollow screw 10 against the rotating of the hollow screw 10 around the longitudinal axis L. This rotation resistance may guarantee a set angle position of the hollow screw 10 around the longitudinal axis L. Furthermore, the rotation resistance has a stabilizing effect in terms of possible vibrations of the adjustment element 1 which could lead to a rotating of the hollow screw 10.

The friction fit between the inside of the fastening opening 16 and the radial outside of the support sleeve 40 may depend on the shape of the support sleeve 40. According to a configuration, the support sleeve 40 may be configured hollow-cylindrically (see FIG. 6a). For increasing the rotation resistance, radially projecting axial ribs 28, a knurling, projecting knobs and/or teeth are provided on the radial outside 48 of the support sleeve 40 and/or on the radial inside 26.

According to a further configuration of the support sleeve 40, the same may include a circumferential end collar 46 (see FIG. 6b). The end collar 46 provides and additional attachment surface at the hollow screw 10 which increases the rotation resistance and provides an axial limitation in the direction of the fastening opening 16. In addition, the same features may be provided on the radial outside of the support sleeve 40′ as in the support sleeve 40 according to FIG. 6a.

As a further embodiment, FIG. 6 shows a support sleeve 40″ having the shape of a truncated cone. The truncated cone-like support sleeve 40″ has an outer diameter Dn. The outer diameter Dn may be larger than the inner diameter of the fastening opening 16. The radial outside may be provided with the same constructive features as the support sleeve 40 according to FIG. 6a.

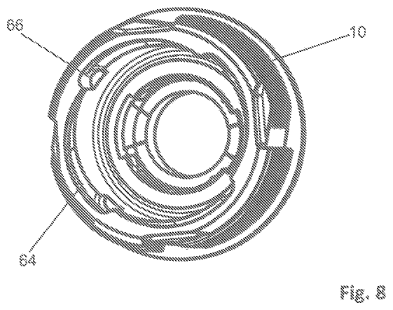

On a face side of the support sleeve 40 facing the support disc 50 (not shown), FIG. 7 may show partial recesses, ribbings, teeth or any selection or combination thereof. They may serve for increasing the friction value between the fastening means 90 and the support sleeve 40 transmitted by the support disc 50.

According to a further configuration, the hollow screw 10 comprises a drive feature 60 at the first axial end 6 adjacent to the fastening collar 20 on the radial outside. The drive feature 60 may be a polygon, which may be a hexagon. It is arranged directly on the outside of the hollow screw 10.

According to a further constructive alternative, an axial projection 62 may be provided at the first axial end 6. It may have a smaller diameter than the hollow screw 10 in the portion of the outer thread 14. In this way, the drive feature 62 includes a radial free space which facilitates the engagement of a positive matching tool.

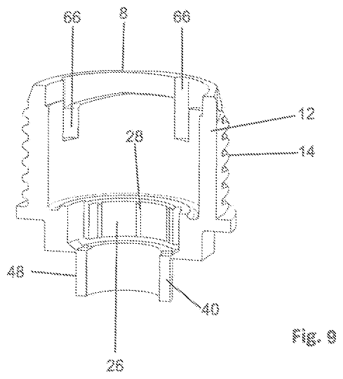

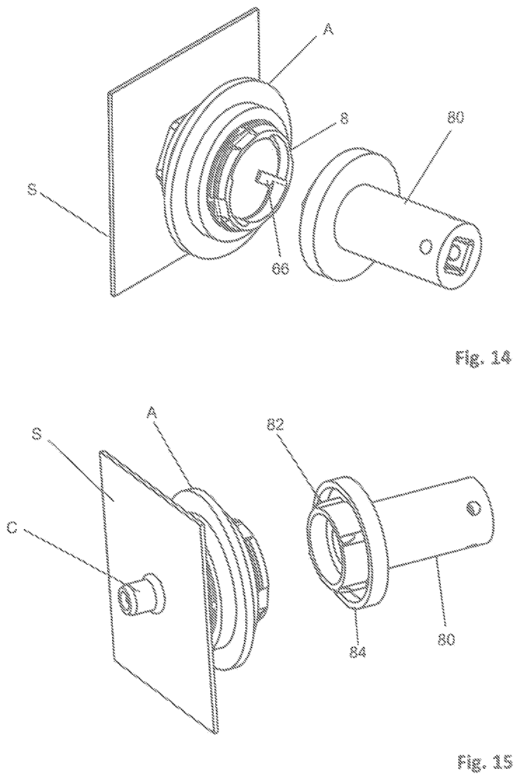

According to a further embodiment, the hollow screw 10 may have a radially inboard drive feature 64 at the second axial end 8. The inboard drive feature 64 may be adapted to form a form fit rotation connection with a tool 80. For this purpose, the radial inside of the circumferential wall 12 has a plurality of axially extending radially outwardly recessed grooves 66. The grooves 66 may be evenly distributed on the inner circumference of the hollow screw 10. The form-fit adapted tool 80 comprises evenly distributed axial webs 82 which engage into the grooves 66 (see FIGS. 8, 9, 12, 14).

The grooves extend in axial direction starting at the second axial end 8. The end of the grooves 66 facing away from the second axial end 8 each form a radial recess in order to hold the engaging axial web 82 of the tool 80. At a certain axial depth of the grooves 66, which may be ramp slopes 68 connect adjacent grooves 66. The ramp slopes 68 reduce the radial height of the radial limiting walls of the radial recess 66. As soon as an engaging axial web 82 reaches the ramp slope 68 and leaves the lower groove 66 because the tool 80 is removed from the second axial end 8, the form fit connection between the tool 80 and the hollow screw 10 is released.

When the tool 80 is for example rotated clockwise, the hollow screw 10 is screwed into the add-on part A. Meanwhile, the add-on part A moves in the direction of the second axial end 8 and encounters the tool 80 in form of the skirt 84. The skirt 84 encompasses the axial webs 82 at a radial distance. Furthermore, the skirt 84 extends in axial direction so that it partly covers the axial webs 82.

When the hollow screw 10 is screwed into the add-on part A, the tool 80 is moved through the add-on part A by means of the skirt 84 in the direction of the second axial end 8. Due to this movement in axial direction of the hollow screw 10, the axial webs 82 are displaced from the engagement in the grooves 66 into the portion of the ramp slopes 68, causing the form fit between tool 80 and hollow screw 10 to be released. In this way, it is avoided that the hollow screw 10 can be screwed out of the engagement with the add-on part A.

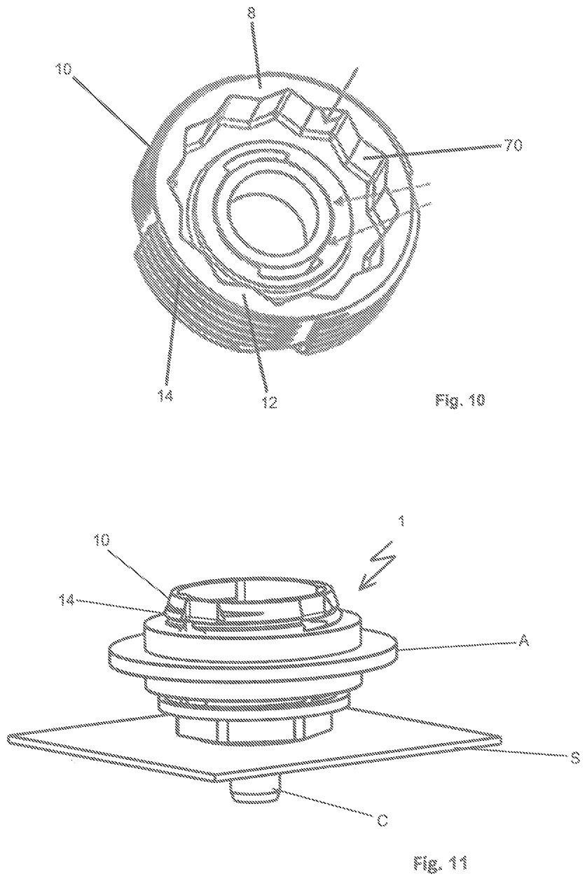

A further embodiment of an inboard form fit drive feature is shown in FIG. 10. A polygonal profile 70 is provided on the radial inside of the wall 12. A complementary formed tool can engage into this profile so that a torque between tool and hollow screw 10 can be transmitted. The tool may be configured similarly as the tool 80 with skirt 84. Instead of the axial webs 82, a polygonal structure is formed which engages the polygonal profile 70 in a form fit manner.

FIG. 11 shows an embodiment of an adjustment element 1 which may be fastened to a structural component S by means of a blind rivet nut C. The blind rivet nut C has been set into a fastening opening B of the structural component S. The adjustment element 1 is screwed together with the blind rivet nut C by means of a thread bolt 90 (not shown). The add-on part A is screwed onto the outer thread 14 of the hollow screw 10 and fastened there. The structural component S may be a part of the body of a vehicle and the add-on part A is a light.

FIGS. 12 and 13 illustrate a simplified installation of the add-on part A to the structural component S. For preparing the installation method, the adjustment element 1 may be screwed into an opening of the add-on part A, which may be_a lamp. That means that the add-on part A and the adjustment element 1 are available to the worker as a prepared component who only needs to fasten same to the structural component S and adjust the add-on part A in terms of its position.

In order to facilitate the fastening of the add-on part A to the structural component S for the worker, a fastening opening B in the shape of a thread opening is provided in the structural component S. According to a first embodiment, the fastening opening B may have an inner thread at its radial inner wall. The add-on part A with adjustment element 1 and a thread bolt 90 arranged in there in a loss-proof manner having a support disc 50 may be provided for the worker. The worker then screws the thread bolt 90 into the fastening opening B and fastens the add-on part A. After that, the distance between the add-on part A and the structural component S is changed with the help of the tool 80 according to a desired clearance.

According to a further embodiment, a blind rivet nut C may be fastened in the fastening opening B. Same provides a fastening thread for the thread bolt 90. The installation method proceeds accordingly as described above, with the exception that the thread bolt 90 is screwed into the inner thread of the set blind rivet nut C (see FIG. 13).

At the add-on part A, the preinstalled adjustment element 1 already comprises a blind rivet nut C arranged on the thread bolt 90. Therefore, the worker may arrange the add-on part A in a fitting manner in the structural component S, with the shaft 92 of the thread bolt 90 with preinstalled blind rivet nut C being inserted into the fastening opening B of the structural component S. As soon as the blind rivet nut C has been arranged in a fitting manner, the worker starts rotating the thread bolt 90 with the help of a suitable tool. The blind rivet nut C is set into the fastening opening B of the structural component by means of the rotation of the thread bolt 90 and the adjustment element 1 is fastened. After that, the worker adjusts the distance between the structural component S and the add-on part A (see FIG. 13).

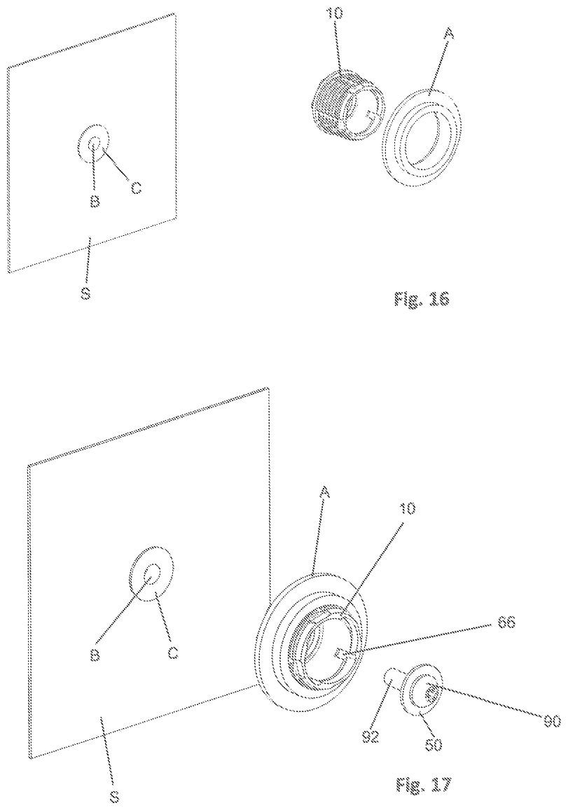

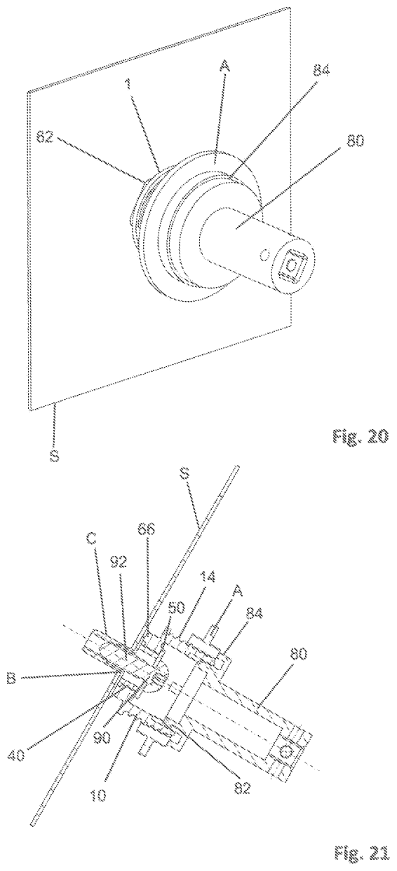

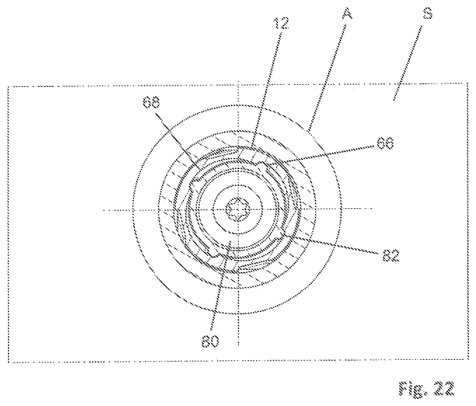

In FIGS. 16-18, steps of an installation method of the add-on part A are shown at a structural component S with the help of an adjustment element 1. In addition to that, FIGS. 19 and 20 show steps for changing a distance between the structural component S and the add-on part A according to a desired clearance or other arrangement concepts.

Firstly, the structural component S with a fastening opening B and a blind rivet nut C fastened in there is provided (step S1, FIG. 16).

As a further preparation of the installation of the add-on part A, the hollow screw 10 or the complete adjustment element 1 may be screwed into an opening of the add-on part A (step S2a, FIG. 16).

According to a further configuration, the add-on part A with adjustment element 1 already fastened to it may be delivered or provided (step S2b). Therefore, the worker does not have to screw the adjustment element 1, which may be the hollow screw 10, in an opening of the add-on part A.

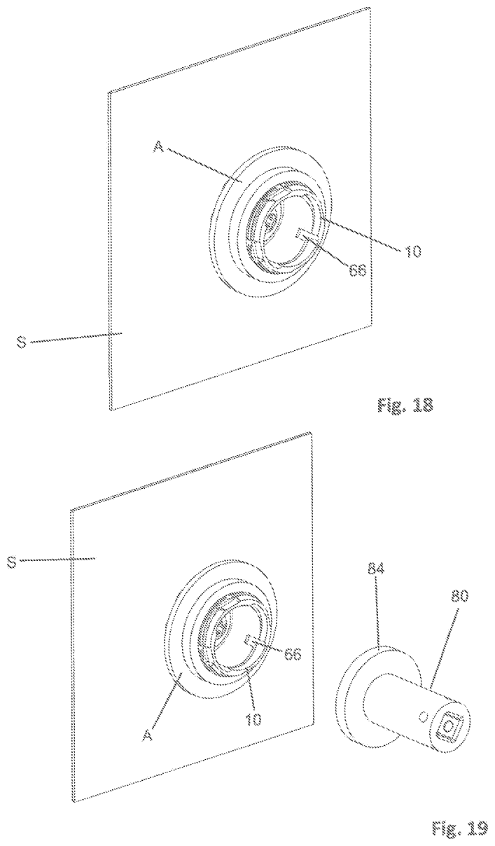

The thread bolt 90 is or will be arranged jointly with the support disc 50 within the axial support sleeve 40 (step S3). Due to the arrangement of the support sleeve 40 between the support disc 50 and the structural component S, the hollow screw 10 is rotatably held at the structural component S even after the thread bolt 90 has been tightened (FIGS. 17, 18).

After having arranged the thread bolt 90 in the adjustment element 1 and in the fastening opening B of the structural component S, the thread bolt 90 is screwed together with the thread of the fastening opening B and fastened with it (step S4a).

Before or during screwing tight the thread bolt 90 in the fastening opening B, the adjustment element 1 is moved in the plane of the structural component in order to compensate tolerances (see above and FIG. 1).

The lateral tolerance compensation may be enabled as a result of the inner diameter of the support sleeve 40 being larger than the outer diameter of the shaft 92 of the thread bolt 90 which passes through the support sleeve 40 (step S4b).

Once the add-on part A has been fastened to the structural component S by means of the adjustment element 1, the hollow screw 10 is rotated with the form-fit/positively acting tool 80. With the help of the rotation of the hollow screw 10, the distance between the structural component S and the add-on part A changes (step S5).

The positively acting tool 80 may engage into the second axial end 8 of the hollow screw 10. A structure is provided there, which may be at the radial inner side of the wall 12, which guarantees a form-fit and releasable rotation connection with the tool 80 (see FIGS. 19, 21 and 10).

The hollow screw 10 may be rotated with a tool by means of the radially outer drive feature 60 so as to set the distance suitably (step S6).

As can be seen from the sectional view in FIG. 21, the skirt 84 of the tool 80 guarantees that the hollow screw 10 is not screwed out from the add-on part A (see above).

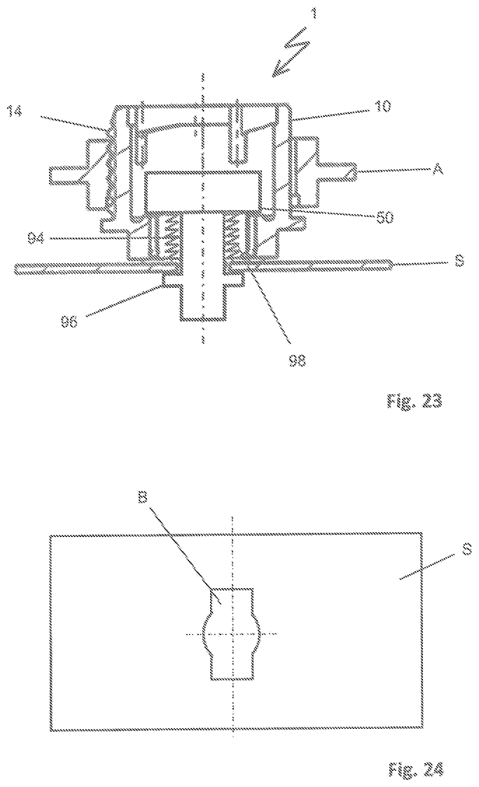

For the sake of completeness and with reference to FIGS. 23 to 26, different alternative embodiments of the fastening means are shown which may be used instead of the thread bolt 90. FIG. 23 shows the use of a latching bolt 94 having a locking web 96 in connection with an additional spring element 98, e.g. in the shape of a circumferential spiral spring or an elastomer ring as fastening means. The associated FIG. 24 illustrates the necessary fastening opening B in the structural component S.

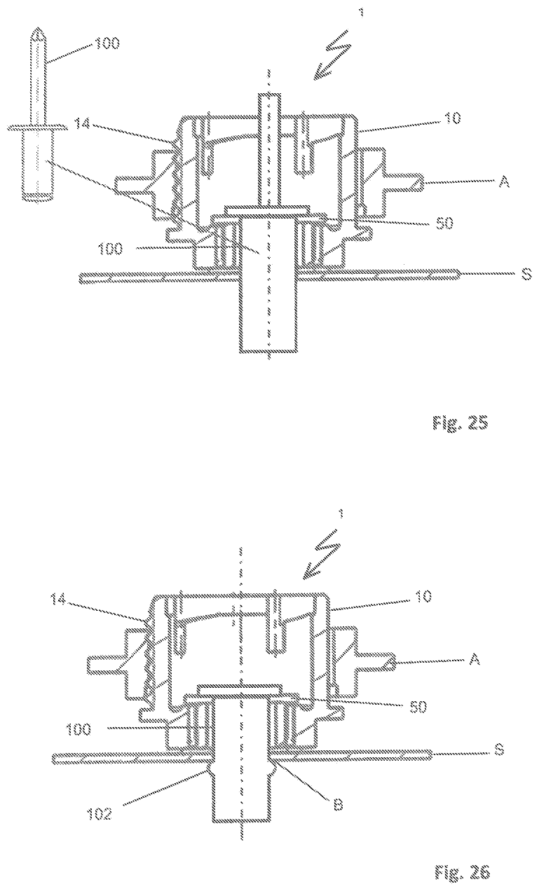

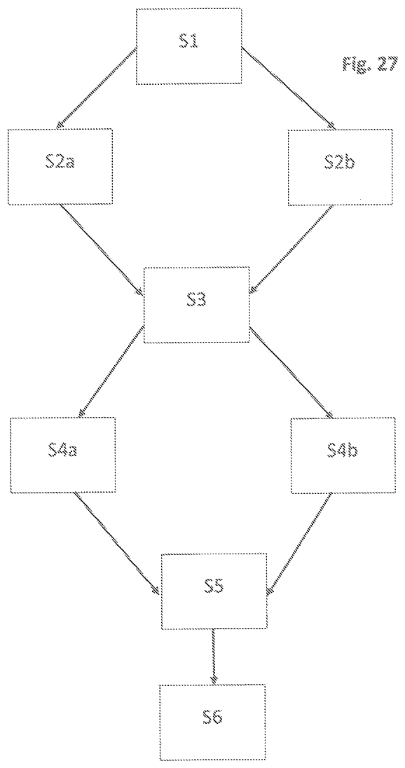

FIGS. 25 and 26 in turn show the use of a blind rivet nut 100 as fastening means. In FIG. 25, the adjustment element 1 is present in a non-fastened arrangement in the fastening opening B of the structural part S, complementary to that, a schematic single illustration of the used blind rivet 100 is shown on the left side in FIG. 25. In contrast to that, FIG. 26 illustrates the adjustment element 1 in a fastened arrangement. It can therefore be seen here that a compressed bead 102 has been formed.

These different fastening means may all fulfil the same function as the thread bolt 90 as fastening means. The adjustment element 1 may be fastened to the structural component S by means of these fastening means, wherein a rotation of the hollow screw 10 can be realized even after fastening the hollow screw 10 to the structural component S.

1. An adjustment element with which a component is fastenable and positionable in the space, including the following features:
a. a sleeve-like hollow screw with a first and a second axial end, a drive feature and an outer thread to which a component is retainable and is positionable in axial direction of the hollow screw,
b. adjacent to the first axial end, the hollow screw comprises a fastening collar which is configured integrally and projects radially to the inside and which encompasses a tubular fastening opening of the hollow screw, and
c. an axial support sleeve is arranged within the tubular fastening opening so that the hollow screw is rotatably fastenable with a fastening means to a component, which passes through the axial support sleeve.

2. The adjustment element according to claim 1, the axial support sleeve of which is flush with the hollow screw at the first axial end and projects beyond an end, located inside of the hollow screw, of the tubular fastening opening so that the hollow screw is rotatably fastenable with the fastening means.

3. The adjustment element according to claim 2, to which end of the support sleeve located inside of the hollow screw, a support disc with a central opening is arranged, the outer disc diameter of which exceeds an outer diameter of the axial support sleeve and the opening diameter of which is smaller than an inner diameter of the axial support sleeve so that a lateral tolerance compensation is providable by means of a combination of the axial support sleeve, the support disc and the fastening means.

4. The adjustment element according to claim 1, the hollow screw of which comprises the drive feature on an inside and/or an outside.

5. The adjustment element according to claim 4, the hollow screw of which comprises an outer polygon as the drive feature at the first axial end, which encompasses at least partly the tubular fastening opening.

6. The adjustment element according to claim 4, the hollow screw of which includes a form fit inner drive feature adjacent to the second axial end.

7. The adjustment element according to claim 1, in which the hollow screw and/or the support sleeve comprise(s) a remainder of a released and previously connecting predetermined breaking point between the support sleeve and the hollow screw.

8. The adjustment element according to claim 1, in which the hollow screw and the support sleeve are made of the same plastic material or of different plastic materials.

9. A structural component with a fastening opening to which the adjustment element according to claim 1 is fastened with a fastening means.

10. The structural component according to claim 9, wherein a component is fastened on the outer thread of the hollow screw of the adjustment element so that tolerances between the structural component and the component are settable.

11. An installation method with which an add-on part is fastenable and positionable to a structural component with the installation method comprising the following steps:
a. screwing-in a hollow screw of the adjustment element according to claim 1 into a retention opening of the add-on part,
b. fastening the hollow screw with add-on part to a fastening opening of the structural component with a fastening means that is arranged within the tubular fastening opening of the fastening collar, and
c. rotating the hollow screw that is fastened to the structural component so that the add-on part is displaced along a longitudinal axis of the hollow screw.

12. The installation method according to claim 11, with the further step:
providing the fastening opening of the structural component with a thread, the thread being configured in a matching manner to a thread bolt serving as a fastening means.

13. The installation method according to claim 11, with the further step:
arranging the thread bolt in combination with a support disc in the axial support sleeve so that the hollow screw is rotatably fastened to the structural component.

14. The installation method according to claim 11, with the further step:
rotating the fastened hollow screw by means of an outer or an inner drive feature in order to change the axial position of the add-on part on the hollow screw.

15. An injection molding method with which an adjustment element according to claim 1 is producible, comprising the following steps:
a. providing an injection mold having the complementary mold features with respect to the adjustment element,
b. injection molding the adjustment element with a first plastic material.

16. The injection molding method according to claim 15 with the further step:
c. injection molding a support sleeve in the injection mold so that the hollow screw and the support sleeve are available being connected by means of a predetermined breaking point.

17. The injection molding method according to claim 16 with the further step:
d. demolding the hollow screw with the support sleeve, wherein the hollow screw and the support sleeve are separated from each other at the predetermined breaking point and the support sleeve is arranged in the tubular fastening opening.

18. The injection molding method according to claim 15, wherein the injection molding method is a 1K injection molding method and the hollow screw and the support sleeve are made of the same plastic material or wherein the injection molding method is a 2K injection molding method and the hollow screw and the support sleeve are made of different plastic materials.
